(19) United States
(12) Patent Application Publication
(10) Pub. No.: US 2011/0033087 A1
(43) Pub. Date: Feb. 10, 2011

(54) VIDEO CONTENT ANALYSIS

(76) Inventors: Alan M. Finn, Hebron, CT (US); Christian M. Netter, West Hartford, CT (US); Pei-Yuan Peng, Ellington, CT (US); Steven B. Rakoff, Toronto (CA); Pengiu Kang, Yorktown Heights, NY (US); Ankit Tiwari, East Hartford, CT (US); Ziyou Xiong, Wethersfield, CT (US); Lin Lin, Manchester, CT (US)

Correspondence Address: CARLSON, GASKEY & OLDS, P.C., 400 WEST MAPLE ROAD, SUITE 350, BIRMINGHAM, MI, 48009, US

(21) Appl. No.: 12/936,690

(22) PCT Filed: Apr. 9, 2008
(86) PCT No.: PCT/US08/59716

§ 371 Date: Oct. 7, 2010

(51) Int. Cl. G06K 9/00; H04N 17/00

(52) U.S. Cl. 382/103; 348/180; 348/E17.001

(57) ABSTRACT

A video content analysis (VCA) system generates an output regarding a detected condition that provides an indication of a confidence level regarding the detected condition. One example VCA system determines whether a first characteristic of a detected object in a field of vision of the video content analysis system satisfies a first criterion. If so, a first signal is generated under selected conditions. The VCA system also determines whether a second characteristic of the detected object satisfies a corresponding second criterion. If so, a second, different signal is generated if the first and second criteria are satisfied. The first and second signals indicate respective, different confidence levels that an event has occurred. A disclosed example includes a VCA as part of a security system.

### BACKGROUND

Video content analysis (VCA) systems allow for automatically analyzing live video streams for a variety of purposes. For example, security surveillance may rely upon a VCA system to detect suspicious activities, events or behavior patterns.

Typical VCA systems include capabilities for moving object detection, tracking, classification and behavior analysis. VCA systems also facilitate automatically generating an alarm when an undesirable condition is indicated by the content of the video stream analyzed by the VCA system.

For example, a tripwire cross over event occurs when an object crosses over a user-defined tripwire (e.g., from one side to the other). A tripwire is a line segment that is defined by two coordinate pairs (e.g., x, y) representing two ends of the tripwire line segment. Depending on the user's defined acceptable direction of detection, an alarm will be triggered when an object crosses the tripwire in an unauthorized or unacceptable manner.

One example patent describing video tripwires is U.S. Pat. No. 6,696,945. Another patent is U.S. Pat. No. 5,696,503, which shows video detection of vehicles crossing a point on a highway.

There are limitations to existing VCA systems. One limitation is that the VCA system tends to be affected by factors such as environmental lighting changes, shadows of moving objects and segmentation of objects, for example. Accordingly, when a moving object is detected and tracked by a VCA system, the position of the object from the tracking module is only an estimate of the true position. In other words, VCA systems are not capable of providing an absolutely true indication of an object's location relative to an area of interest.

Additionally, the video equipment utilized to obtain the video stream (e.g., video cameras) has inherent limitations such as camera jitter. Such features of a camera lend to additional inaccuracies in the information obtainable from the VCA system. There are other sources of potential noise in a VCA system that contributes to inaccuracies.

As a result, VCA systems may trigger false alarms in the event that the VCA system determines that an object has improperly crossed a boundary when, in reality, no such crossing has occurred (e.g., the VCA system provides a false positive result). It is also possible for a typical VCA system to miss the actual crossing of an established tripwire boundary. This may occur, for example, when the information provided by the VCA system does not indicate a crossing even though, in reality, the object has crossed the established limit (e.g., the VCA system provides a false negative result). Typical VCA systems provide these false positive and false negative results usually because the system is designed to issue an alarm immediately once the VCA system estimates that the position of a tracked object crosses an established tripwire. Because of the inherent inaccuracies in a VCA system, it is possible to miss alarm-raising conditions and to raise an alarm when there is no reason for doing so.

### SUMMARY

An exemplary method of operating a video content analysis (VCA) system includes generating an output regarding a detected condition that provides an indication of a confidence level regarding the detected condition.

One example includes determining whether a first characteristic of a detected object in a field of vision of the VCA system satisfies a corresponding first criterion. A first signal is generated if the first criterion is satisfied. A determination is also made whether a second characteristic of the detected object satisfies a corresponding second criterion. A second, different signal is generated if the first and second criteria are satisfied. The distinct first and second signals provide different indications of a confidence level regarding the detected condition.

One example includes determining whether a third characteristic satisfies a third criterion. An indication is provided to a user corresponding to the generated first or second signals if the third criterion is satisfied.

An exemplary video content analysis system generates an output regarding a detected condition that provides an indication of a confidence level regarding the detected condition.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an example video content analysis system.

FIG. 2 is a flowchart diagram summarizing one example approach.

FIG. 3 schematically illustrates one example scenario.

FIG. 4 schematically illustrates another example scenario.

FIG. 5 schematically illustrates another example scenario.

### DETAILED DESCRIPTION

The disclosed examples provide a video content analysis (VCA) system and technique that minimizes or eliminates false positive and false negative indications regarding a variety of potential events that are observable using the VCA. A hierarchical approach facilitates providing an indication of a confidence level regarding a detected condition which yields more reliable indications to a user regarding conditions potentially detected by the VCA.

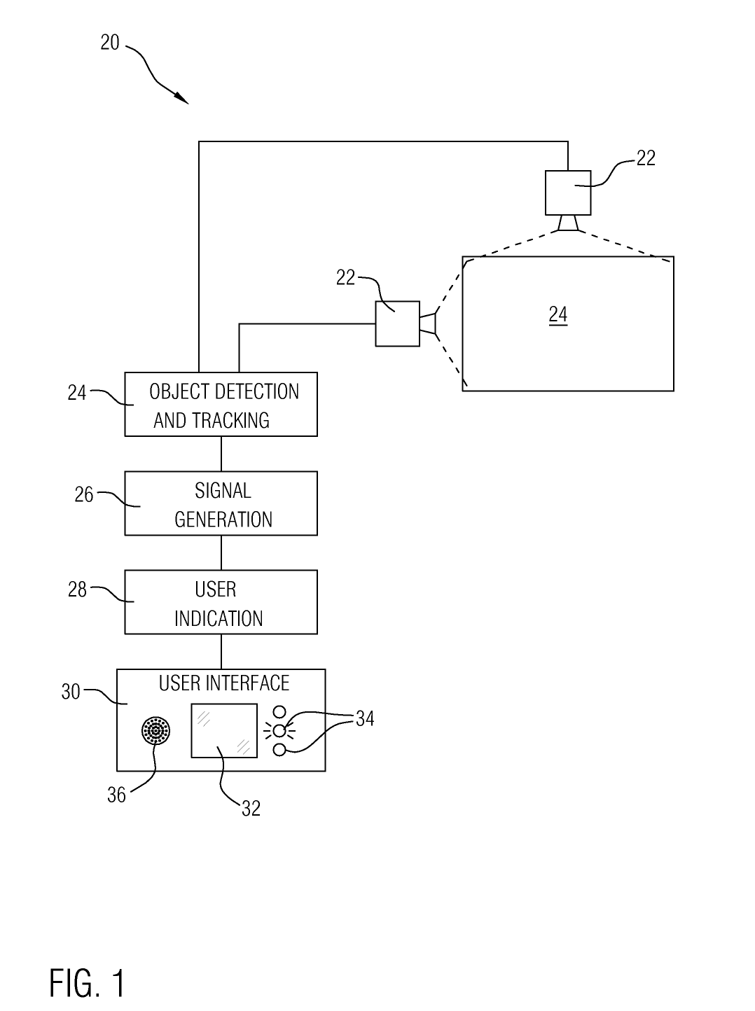

FIG. 1 schematically shows an example VCA system 20 including video surveillance equipment 22. One example includes video cameras as the video surveillance equipment 22. The video surveillance equipment 22 provides the ability to observe an area of interest 24 for at least one of a variety of purposes.

An object detection and tracking portion 24 obtains information from the video surveillance equipment 22 for detecting an object within the field of vision of the VCA system 20 and for tracking any progress of the object within the area of interest 24.

A signal generation portion 26 generates signals that indicate conditions within the area of interest 24 based upon information from the object detection and tracking portion 24 regarding at least one characteristic of a detected object (e.g., position, speed, direction, etc.). In one example, the type of signal provides an indication of a confidence level regarding a detected condition.

A user indication portion 28 selectively provides an indication to a user regarding one or more signals from the signal generation portion 26.

A user interface 30 facilitates providing the indication to a user. In this example, the user interface 30 includes a display screen 32 that is capable of displaying an image of what is or has been observed through the video surveillance equipment 22, for example. The user interface 30 in this example includes a plurality of visible indicators 34 that can be used to provide a visible indication to a user such that the user is able to determine what types of signals have been generated by the signal generation portion 26. The example user interface 30 also includes an audible output portion 36 (e.g., a speaker) for providing an audible indication to a user.

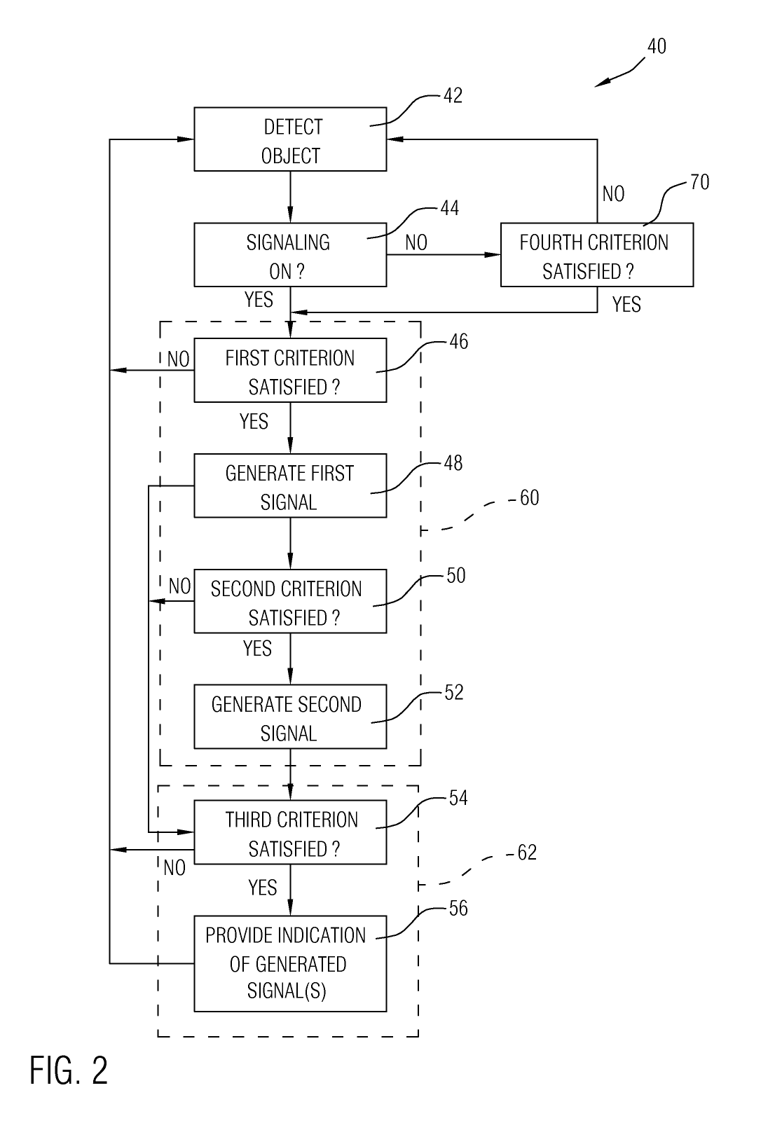

FIG. 2 includes a flowchart diagram 40 that summarizes one example approach for utilizing the VCA system 20 of the example of FIG. 1. The example flowchart begins at 42 where an object is detected by the object detection and tracking portion 24. A determination is made at 44 whether the signaling function of the VCA system is activated. If so, a decision is made at 46 whether a first criterion is satisfied. This decision includes determining whether a first characteristic of a detected object in a field of vision of the surveillance equipment 22 satisfies a corresponding first criterion. At 48, a first signal is generated if the first criterion is satisfied. If the first criterion is not satisfied, the process returns to detecting or tracking the object at 42.

If a first signal has been generated at 48, a determination is made at 50 whether a second criterion is satisfied. One example includes determining whether a second characteristic of the detected object satisfies a corresponding second criterion. If so, a second signal that is different than the first signal is generated at 52. Even if the second criterion is not satisfied at 50, the first signal generated at 48 is forwarded on for further processing.

In the example of FIG. 2, a determination is made at 54 whether a third criterion is satisfied. If so, an indication is provided at 56 to a user such that the user has an indication of the generated signal or signals. The user is provided with an indication of a confidence level regarding a detected condition based on which signal(s) resulted in the indication provided at 56. If the third criterion is not satisfied at 54, then no such indication is provided to a user (e.g., an individual) and the example process returns to the step at 42 for detecting and tracking an object.

One feature of utilizing multiple criteria for determining whether to provide an indication to a user in the illustrated example is that it minimizes or eliminates the occurrence of false positive and false negative alarms being raised by a VCA system that is used for security purposes as an example. In the example of FIG. 2, the steps at 60 can be considered a first filtering level for filtering information obtained by the VCA system 20 prior to providing an indication to a user regarding information obtained by the VCA system 20. The steps at 62 can be considered part of a second filtering level, which further controls whether an indication is provided to a user regarding any detections made by the VCA system 20. Having more than one filtering level provides a hierarchical strategy for controlling when a user receives information from the VCA system 20. This approach minimizes or eliminates false positives, false negatives and compensates for inherent limitations of the VCA system 20 such as camera jitter or noise in the system, for example.

The example of FIG. 2 includes a third filtering level including a determination made at 70 whether a fourth criterion is satisfied. In this example, the fourth criterion is used for determining whether the signaling function (of the example signal generation portion 26) should be activated or not. A variety of criteria may be used for determining when information from the VCA system 20 would be useful or pertinent and controlling the signaling function accordingly. In the example of FIG. 2, if the fourth criterion is satisfied, the signaling function is activated or turned on and the determinations made by the first filtering level 60 and second filtering level 62 may proceed. If the fourth criterion is not satisfied in this example, the procedure returns to the step at 42 for detecting an object and none of the steps that are part of the first filtering level 60 or the second filtering level 62 need be performed.

The illustrated example is useful for a variety of situations. One example includes determining when a detected object (e.g., a person, an animal, a vehicle, etc.) within the area of interest 24 has crossed over a boundary indicating that the object is in a location where it should not be.

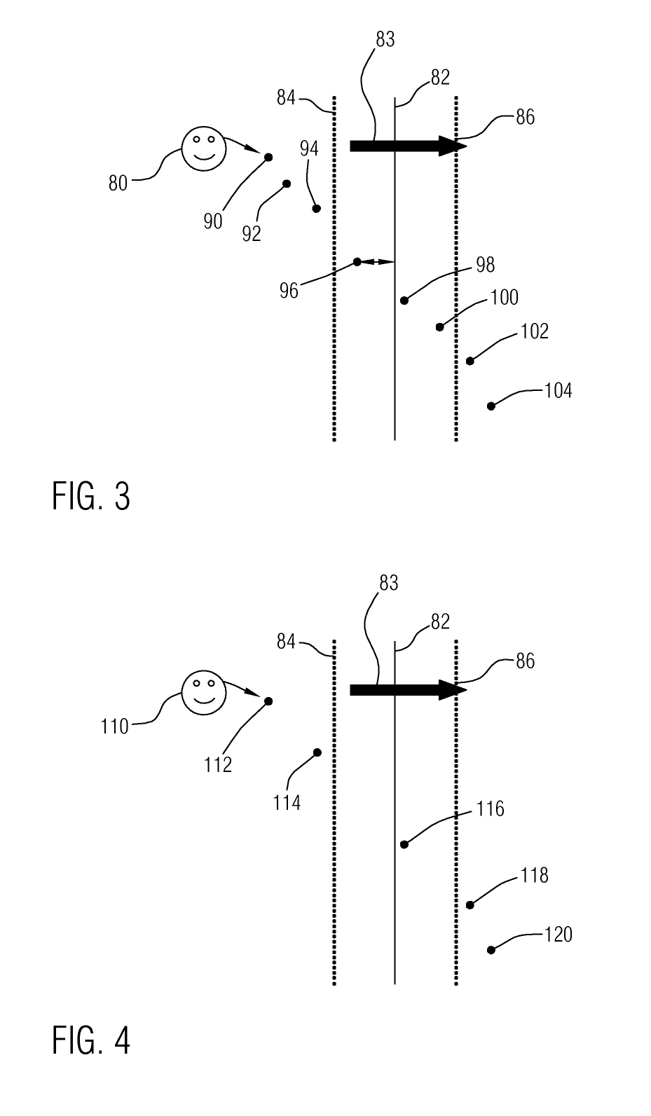

FIG. 3 schematically illustrates an arrangement where an object 80 is detected at a plurality of locations relative to an established boundary 82 over time. In this example, there is concern regarding an object moving in the direction 83 across the boundary 82 (e.g., from left to right in the drawing). The boundary 82 is represented within the VCA system 20 by establishing a detection boundary using a known technique. This example includes establishing a range of distance around the boundary 82 including distance thresholds 84 and 86 on opposite sides of the boundary 82.

In this example, the first distance threshold 84 corresponds to the first criterion in the example of FIG. 2. The step at 46 corresponds to determining when the detected object 80 has crossed over the threshold 84 (e.g., the orthogonal distance between the location of the object 80 and the boundary 82 is within the preselected range d0). In FIG. 3, the object 80 is detected at a plurality of locations 90, 92, 94, 96, 98, 100, 102 and 104, respectively. At any point where the detected object comes within the selected range of the boundary 82, the first criterion is satisfied and a first signal will be generated such as at the step 48 in FIG. 2. In this example, the first signal corresponds to a warning signal that the detected object is within a range of the boundary 82 that raises a suspicion that the object is likely to or potentially has already crossed the boundary 82 in reality. In FIG. 3, the first criterion is not satisfied at the locations 90, 92 and 94. Once the detected object 80 reaches the location at 96, the first criterion has been satisfied because the distance between the detected location at 96 and the boundary 82 is within the range established by the threshold 84. Accordingly, a first signal (e.g., a warning or suspicion signal) is generated once the detected object 80 reaches the location indicated at 96.

FIG. 3 schematically illustrates subsequent movement of the object 80 to the positions located at 98 and 100. In each of these locations, the first criterion is still satisfied. In this example, no further first signals are generated corresponding to the detected locations at 98 and 100. In this example, once a first signal (e.g., a warning or suspicion signal) is generated, there need not be a second warning within a user-defined period of time. One reason to include a delay between consecutive generations of a first signal is to accommodate for system jitter that makes a close object look like it has moved to a position according to the VCA output when, in fact, the object has not moved to that position. For example, noise or camera jitter may cause one of the detected positions 90-104 to be at a different position relative to the boundary 82 than the object 80 is in reality. By delaying subsequent generation of a first signal, such system noise can be addressed. For example, if a single first signal is generated over a selected amount of time, it is possible to consider whether that signal is generated based upon system noise as opposed to an actual object location relative to the boundary 82. One example includes the recognition that such system jitter or noise only affects a few video frames at most lasting over a period of 66 milliseconds, for example. The user defined interval between consecutive generations of a first signal in one example is set with that timing in mind. Controlling how often the first signals are generated contributes to addressing noise in the VCA system that may give rise to a false positive indication, for example.

Once the object 80 reaches the location indicated at 102, a second criterion is satisfied. In this example, the second criterion includes whether the object 80 has crossed the boundary 82 (in the direction of concern) and passed it by a distance exceeding the threshold 86. For example, once a detected position of an object has crossed a boundary beyond a certain point, that is an indication that in fact the object has crossed the boundary in reality and the locations 102 and 104 are not likely the result of noise or jitter in the VCA system. Once the second criterion is satisfied, a second signal is generated at 52 in the example of FIG. 2.

The second signal is different than the first signal in this example by being an actual alarm signal. An actual alarm signal indicates a high level of confidence that the boundary 82 has been crossed by the object 80. The first signal, on the other hand, is intended to indicate a lower level of confidence that the boundary 82 has potentially been crossed because it is more of a warning or suspicion signal compared to an actual alarm signal.

In this regard, the illustrated example provides a level of confidence regarding detected characteristics of an object (e.g., location). The first signal in this example provides a lower level of confidence while the second signal provides a higher level of confidence that the boundary 82 has been crossed. In the illustrated example, the generation of the second signal does not occur until after at least one first signal has been generated to facilitate an increasing confidence level prior to generating the second signal. The hierarchical approach (e.g., making second signal generation dependent on first signal generation) adds confidence in the accuracy of the second signal.

Referring again to FIG. 2, the determination at 54 whether a third criterion is satisfied in the case of FIG. 3 includes determining whether a second signal has been generated or multiple first signals have been generated. If only one first signal is generated, the third criterion is not satisfied in this case. Once a second signal or more than one first signal has been generated, the third criterion has been satisfied and an indication is provided to the user at 56 in the example of FIG. 2.

If the user interface 30 of FIG. 1 were used, the indication includes activating one of the visible indicators 34 to indicate that a first signal has been generated and activating another one of the indicators 34 to indicate that the second signal has been generated. At the same time, the display 32 may provide a visual representation of the conditions observed by the VCA system giving rise to the indications provided to the user. For example, the display 32 may show a current view of the area of interest 24 including the boundary 82, a visual representation such as what is shown schematically in FIG. 3 representing what has been observed or both. In one example, one of the indicators 34 corresponding to a first signal includes a yellow light while one of the indicators 34 corresponding to generation of a second signal includes a red light. The user will recognize that a yellow light condition is not as serious (e.g., there is lower confidence regarding the detected condition) and does not require as immediate attention as a red light condition would. Additionally, an audible indication may be provided to the user interface 30 regarding the first signal, the second signal or both.

A user receiving the indications regarding the first signal and second signal can make a decision regarding an appropriate response. For example, if only the indication of the first signal is received, the user's attention and suspicion may be raised without requiring immediate action. For example, closer observation may be warranted. When an indication of a second signal is provided, on the other hand, the user will take appropriate action to address the current situation.

FIG. 4 schematically shows another example situation. An object 110 (e.g., an individual or a vehicle) is detected at a plurality of locations 112, 114, 116, 118 and 120 over time. When the object 110 is at the locations 112 and 114, no signals are generated because none of the criteria have been met for generating a signal. In this example, the position at 116 is the first time that the object 110 is in a position where the first criterion is satisfied (e.g., the object is between the thresholds 84 and 86). In this example, the location 116 is across the boundary 82 but only a first signal will be generated (e.g., a warning or suspicion signal). This addresses the possibility that the detected location 116 has been skewed by noise in the VCA system and the object 110 may not, in fact, be over the boundary 82.

In FIG. 4, the next detected location 118 of the object 110 is past the threshold 86 and a second signal is generated immediately responsive to that detected location.

One difference between the scenarios of FIGS. 3 and 4 is that there are no intervening object location detections between the generation of the first signal and the second signal in FIG. 4 whereas there were several detected locations (e.g., 98 and 100) in FIG. 3 between the generation of the first signal at 96 and the second signal at 102.

It should be noted that in FIGS. 3 and 4, the distances from the boundary 82 established by the thresholds 84 and 86 need not be the same on both sides of the boundary 82. Those skilled in the art who have the benefit of this description will be able to select appropriate ranges on varying sides of a selected boundary to meet the needs of their particular situation. Additionally, the boundary 82 need not necessarily be a single line but could include a rectangular shaped area, for example.

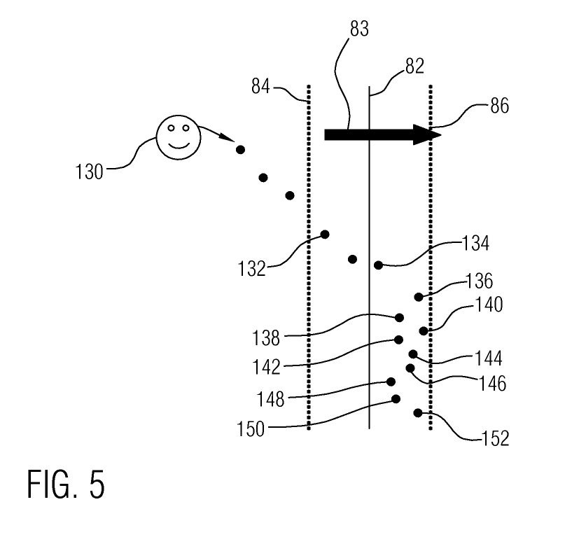

FIG. 5 schematically illustrates another scenario where an object 130 approaches the boundary 82. In this example, a first signal is generated when the object 130 reaches the location shown at 132. At that point, the detected location of the object 130 is within the selected range of the boundary 82 to give rise to a first signal (e.g., a suspicion or warning signal).

In FIG. 5, the detected locations of the object 130 across the boundary 82 (e.g., to the right of 82 according to the drawing) never exceed the limit allowed by the threshold 86. Instead, the detected locations are all in relatively close proximity to the boundary 82. In this example, the second criterion includes determining whether the detected object remains in a selected range of the boundary 82 for at least a predetermined amount of time. If so, a second signal is generated.

In the example of FIG. 5, the detected locations at 134-152 are all across the boundary 82 but within the range established by the threshold 86. A sufficient amount of time has passed between the generation of the first signal based upon the location 132 and the detected location 152 to give rise to generating a second signal (e.g., an actual alarm signal). The amount of time selected for determining when to generate a second signal under such circumstances alleviates any concern that the detected location may be in error because of system noise. The repeated detections of the object location in the illustrated vicinity of the boundary 82 provides a high level of confidence that the object has actually crossed the boundary 82 and the detected locations are trustworthy enough to justify generating an alarm signal. Even if the detected locations 134-152 were inaccurate in the sense that in reality the object 130 was on the opposite side of the boundary 82, the close proximity of the object 130 to the boundary 82 for that many successive location detections is indicative of a situation that is more than just suspicious. In other words, even if each of the detected locations 134-152 corresponded to a false positive indication of the presence of the object 130 on the illustrated side of the boundary 82, the number of such detections provides an indication of a situation that requires a user's attention.

As can be appreciated from the illustrated examples, the two levels of filtering schematically illustrated at 60 and 62 in FIG. 2 provide increased confidence that an indication of actual alarm signal such as a second signal corresponds to an accurate indication of a situation requiring attention.

The illustrated example also includes the third level of filtering corresponding to the fourth criterion of FIG. 2. This third level of filtering may be based upon a schedule such as a time of day, day of the week or other timing considerations. The fourth criterion may also include whether an individual has authorized access to a location. The fourth criterion in one example includes a recognition of a size of an object detected relative to a boundary of interest. For example, it may not be of any concern if a bird crosses the boundary 82 but it may be of concern if a person crossed the boundary 82. Given this description, those skilled in the art will be able to accommodate appropriate criteria to address their particular situation.

Although the scenarios schematically shown in FIGS. 3-5 correspond to an object crossing a threshold in a particular direction, the disclosed example arrangement is not limited to such situations. Other examples include detection in multiple directions relative to a boundary, presence within a region defined by a boundary including multiple tripwire lines and analysis of characteristics of an object that are different than distance to a selected boundary. One example includes determining a velocity or acceleration of an object based upon current state information available through a VCA system. If the object's velocity or acceleration exceeds a desired threshold, a first signal may be generated and if the object continues at that speed or acceleration for a selected time, a second signal may be generated. Another example includes utilizing extrapolation of successive observed states of a particular characteristic such as predicted position, predicted velocity, predicted acceleration or others. Uncertainty estimates about current or extrapolated characteristic states can be accommodated by appropriately configuring the criteria used for the first criterion, second criterion, third criterion and fourth criterion as necessary. Additionally, the criteria may be dynamically adjusted in response to particular situations.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of operating a video content analysis (VCA) system, comprising
generating an output regarding a condition detected by the VCA system such that the output provides an indication of a confidence level regarding the detected condition.

2. The method of claim 1, comprising
determining whether a first characteristic of a detected object in a field of vision of the VCA system satisfies a corresponding first criterion;
generating a first signal if the first criterion is satisfied;
determining whether a second characteristic of the detected object satisfies a corresponding second criterion; and
generating a second, different signal if the first and second criteria are satisfied.

3. The method of claim 2, wherein the first and second signals indicate respective, different confidence levels that an event has occurred.

4. The method of claim 3, wherein the second signal indicates a higher confidence level than the first signal.

5. The method of claim 2, comprising
determining whether a third characteristic satisfies a third criteria; and
providing an indication to an individual corresponding to the first or second signals if the third criterion is satisfied.

6. The method of claim 5, wherein the third criterion corresponds to at least one of
(i) a selected time elapsing after providing an indication corresponding to a first signal, or
(ii) a second signal is generated.

7. The method of claim 2, comprising
determining whether a third characteristic satisfies a third criterion; and
controlling whether the first or second signals are generated dependent on whether the third criterion is satisfied.

8. The method of claim 7, wherein the third criterion comprises at least one of
a time of day,
a day of week,
a size of the detected object, or
an authorization.

9. The method of claim 7, comprising
providing an indication to an individual corresponding to the first or second signal if the third criterion is satisfied.

10. The method of claim 7, comprising
preventing the first and second signals from being generated if the third criterion is not satisfied.

11. The method of claim 2, wherein the first criterion comprises a location of the detected object is within a selected range of a boundary.

12. The method of claim 11, wherein the first criterion comprises a location of the detected object being on a selected side of the boundary.

13. The method of claim 11, wherein the second criterion comprises at least one of
(i) a location of the detected object moving outside of the selected range of the boundary;
(ii) a location of the detected object being outside of the selected range in a selected direction; or
(iii) an amount of time elapsing when a location of the detected object remains within the selected range of the boundary.

14. The method of claim 2, wherein the first criterion comprises a detected object moving at a speed within a selected range of a threshold speed.

15. The method of claim 14, wherein the second criterion comprises at least one of
(i) the detected object moving at the speed within the selected range for a selected amount of time; or
(ii) the detected object moving at a second, higher speed exceeding a second, higher threshold speed.

16. A video content analysis system (VCA), comprising
a signal generation portion that generates an output regarding a condition detected by the VCA system that provides an indication of a confidence level regarding the detected condition.

17. The system of claim 16, comprising:
an object detection and tracking portion that detects an object and determines whether a first characteristic of a detected object corresponds to a first criterion, the object detection and tracking portion determining whether a second characteristic of the detected object satisfied a corresponding second criterion; and wherein
the signal generation portion generates a first signal if the first criterion is satisfied and generates a second, different signal if the first and second criteria are satisfied.

18. The system of claim 17, comprising a user indication portion that generates an indication to a user indicating when a first or second signal is generated.

19. The system of claim 18, comprising a user interface that provides at least one of a visible or audible output to a user responsive to an indication from the user indication portion.

20. The system of claim 17, wherein the first and second signals indicate respective, different confidence levels that an event has occurred.

21. The system of claim 17, wherein the first signal corresponds to a suspicion or warning signal and the second signal corresponds to an alarm signal.

22. The system of claim 17, wherein the first characteristic is different than the second characteristic.
